(19) United States
(12) Patent Application Publication
(10) Pub. No.: US 2021/0331614 A1
(43) Pub. Date: Oct. 28, 2021

(54) OCCUPANT SUPPORT OF A VEHICLE

(71) Applicant: Faurecia Automotive Seating, LLC, Auburn Hills, MI (US)

(72) Inventors: Davide DI CENSO, Sunnyvale, CA (US); Cedric KETELS, Auburn Hills, MI (US); Thomas DESSAPT, Auburn Hills, MI (US); Robert C. FITZPATRICK, Auburn Hills, MI (US)

(21) Appl. No.: 16/859,174

(22) Filed: Apr. 27, 2020

(51) Int. Cl. B60N 3/00; B60R 16/03; B60N 2/01; B60N 2/64

(52) U.S. Cl. CPC B60N 3/001; B60R 16/03; A47B 31/06; B60N 2/64; B60N 2/01

(57) ABSTRACT

An occupant support includes a vehicle seat and a modular system. The vehicle seat includes a seat bottom and a seat back. The modular system is changeable between a stowed configuration and a use configuration.

### BACKGROUND

The present disclosure relates to an occupant support, and particularly to an occupant support included in a vehicle. More particularly, the present disclosure relates to an occupant support which may be reconfigured to provide utility to an occupant of the vehicle.

### SUMMARY

According to the present disclosure, a vehicle includes a first vehicle seat and a second vehicle seat. The second vehicle seat is located rearward of the first vehicle seat.

In illustrative embodiments, an occupant support includes the second vehicle seat and a modular system. The modular system includes a platform and a platform-receiving mount coupled to the first vehicle seat to move therewith. The occupant support allows utility to be improved for a rear passenger resting on the second vehicle seat.

In illustrative embodiments, the modular system is changeable between a stowed configuration and a use configuration. In the stowed configuration the platform is releasably coupled to the platform-receiving mount to move therewith. In the use configuration the platform is decoupled from the platform-receiving mount to allow the platform to move relative to the platform-receiving mount and the seat back such that an occupant of the vehicle may use the platform.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of an occupant support showing that the occupant support includes a vehicle seat and a modular system in a use configuration in which a first platform is separated from a platform-receiving mount coupled to a seat back of the vehicle seat;

FIG. 2 is a view similar to FIG. 1 showing the platform coupled to the platform-receiving mount to establish a stowed configuration of the modular system and suggesting that power outlets and data connection receptacles remain exposed for use by an occupant;

FIG. 3 is an enlarged perspective view of the platform of FIGS. 1 and 2 showing that the platform includes a top platform surface, a side platform wall extending around a perimeter of the platform, a transition surface that extends between the side platform wall and the top platform surface, two power outlets and three data connection receptacles arranged in the transition surface, and an anchor member arranged on the side platform wall;

FIG. 4 is a diagrammatic view of a vehicle including the vehicle seat and the modular system of FIGS. 1-3 showing that the vehicle further includes a vehicle power supply that is connected to the power system of the modular system and that the platform-receiving mount is coupled to the seat back;

FIG. 5 is a perspective view of the platform of FIGS. 1-4 showing the platform in the use configuration in which the platform is decoupled from the platform-receiving mount in the seat back and arranged on the legs of an occupant of the vehicle for use in supporting a laptop computer which is plugged into one of the power outlets;

FIG. 6A is a sectional view taken along line 6A-6A of FIG. 1 showing the modular system in the stowed configuration in which the platform is coupled to the seat back of the vehicle seat;

FIG. 6B is an enlarged sectional view taken along line 6A-6A of FIG. 1 showing the platform in the use configuration in which the platform is decoupled from the seat back of the vehicle seat and showing a data connection of the platform configured to be connected to the power system of the modular system via the first and second anchor members;

FIG. 7 is a sectional view taken along line 7A-7A of FIG. 1 showing that an interior of the platform includes a battery connected to a fan of a thermal control system, a power outlet, a data connection receptacle, and the second anchor member such that the battery may be charged when the second anchor member is coupled to the first anchor member;

FIG. 8 is a perspective and diagrammatic view of another embodiment of an occupant support in accordance with the present disclosure showing that the power system of the modular system includes a power cord configured to extend from the seat back to the platform;

FIG. 9 is a perspective view of another embodiment of a platform in accordance with the present disclosure showing that the platform is formed to include a platform space and suggesting that a vending device is disposed within the platform space; and

### DETAILED DESCRIPTION

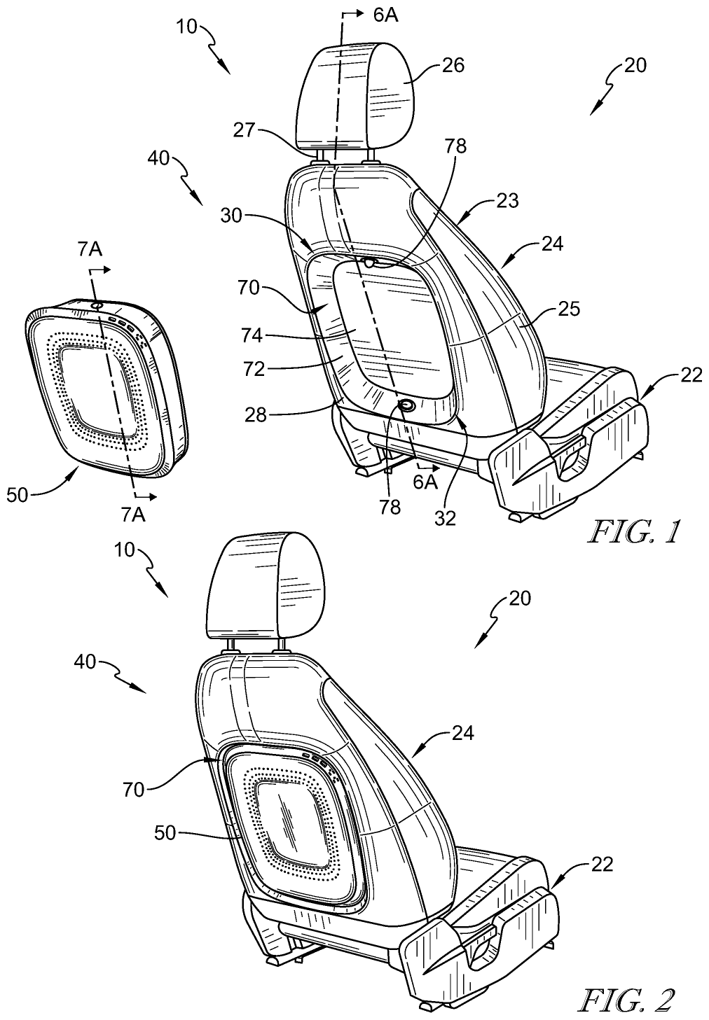

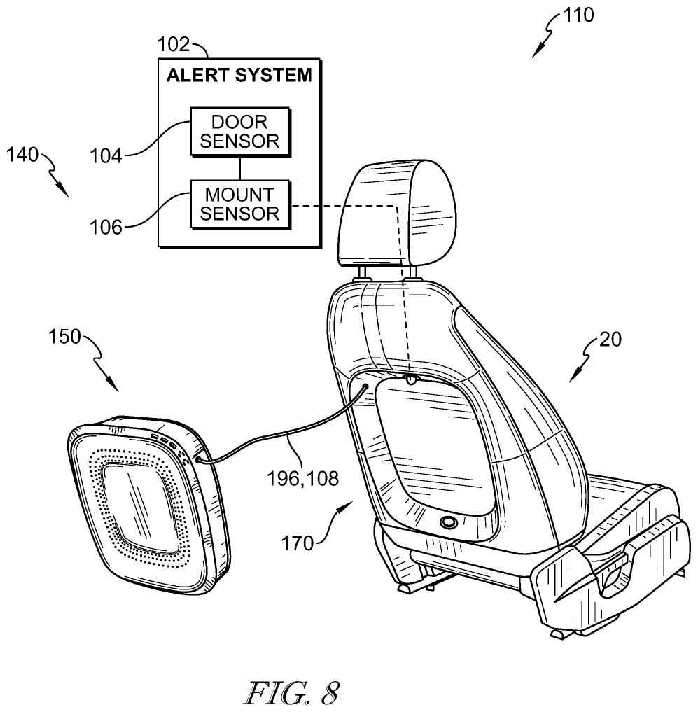

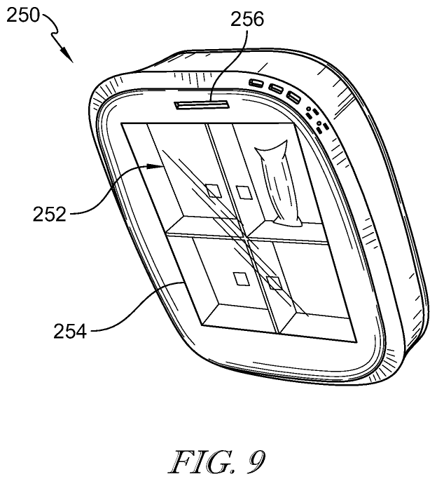

A first embodiment of an occupant support 10 for a vehicle is shown in FIGS. 1-7. In one example, the occupant support 10 is a front-row seat and a modular system 40 is used by an occupant in a rear-row seat. The modular system 40 may provide increased utility, comfort, or other services to the rear occupant. A second embodiment of an occupant support 110 including a modular system 140 is shown in FIG. 8. Another embodiment of a modular system 240 is shown in FIG. 9.

An occupant support 10 for a vehicle 100 in accordance with the present disclosure is shown in FIGS. 1-7. The occupant support 10 includes a vehicle seat 20 and a modular system 40 as shown in FIGS. 1 and 2. The vehicle seat includes a seat bottom 22 and a seat back 24 arranged to extend upwardly away from the seat bottom 22. The modular system 40 is coupled to the seat back 24. In various driving situations, passengers of the vehicle 100 may wish to complete tasks, relax, or other such activities. As such, the modular system 40 is configured to be provided with services and/or features to a passenger of the vehicle 100 for productivity, comfort, relaxation, or other such purposes.

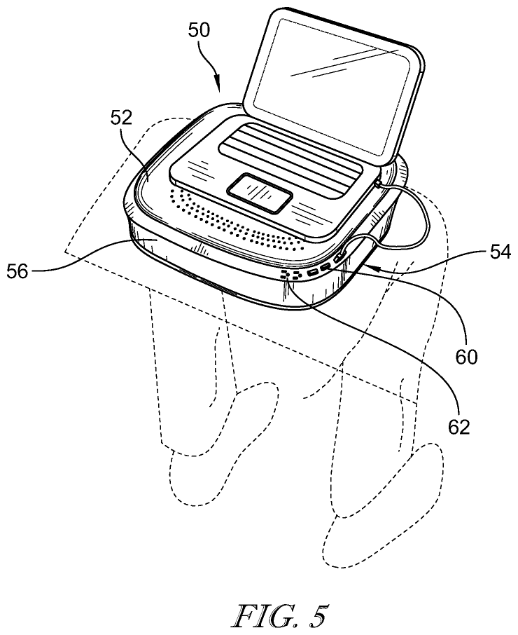

The modular system 40 includes the platform 50 and a platform-receiving mount 70 as shown in FIG. 1. The modular system 40 may be changed between a use configuration, shown in FIG. 1, and a stowed configuration, shown in FIG. 2. In the stowed configuration, the platform 50 is coupled to platform-receiving mount 70 to move therewith so as to be out of the way of an occupant or occupants entering or exiting the vehicle 100. In the use configuration, the platform 50 is decoupled from the platform-receiving mount 70 for use by the occupant. In this way, the occupant may use one of the features and/or services provided by the platform 50 of the modular system 40. In one example, the platform 50 may be used as lap desk for supporting a laptop, as suggested in FIG. 5. In some embodiments, the platform 50 may be configured to provide features and/or services while in the stowed configuration.

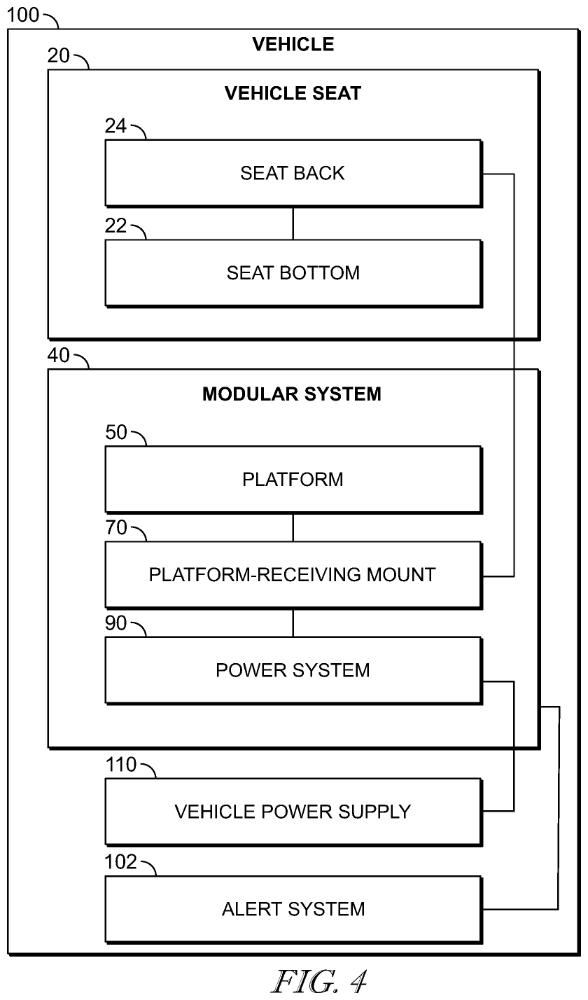

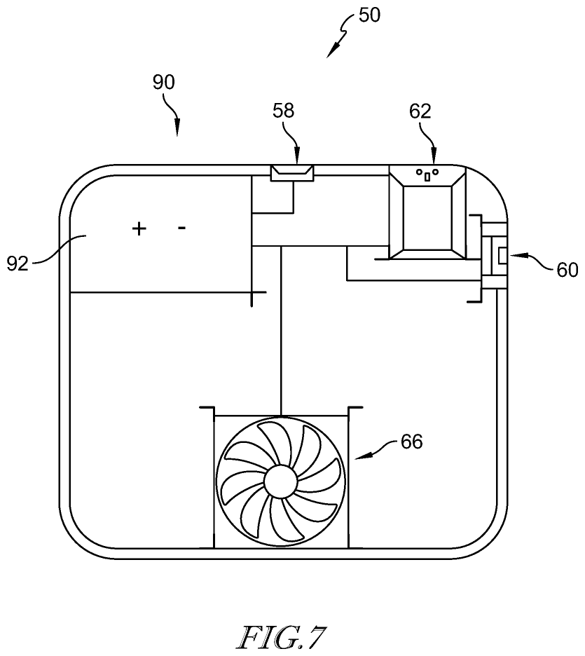

The modular system 40 further includes a power system 90 as shown in FIGS. 4 and 7 and suggested in FIG. 1-3. The power system 90 is configured to continuously supply power to the modular platform 40, in particular to the platform 50, to power the various features and/or services of the platform 50. For example, the power system 90 includes a rechargeable battery 92 that is housed within the platform 50, as shown in FIG. 7. The battery 92 is charged when the platform 50 is mounted to the platform-receiving mount 70, which may be connected to a vehicle power supply 110. In some embodiments, the power system 90 includes a power cord 96 that is permanently connected to the platform 50 so as to continuously supply power to the platform 50 from the vehicle power supply 110, as shown in FIG. 8.

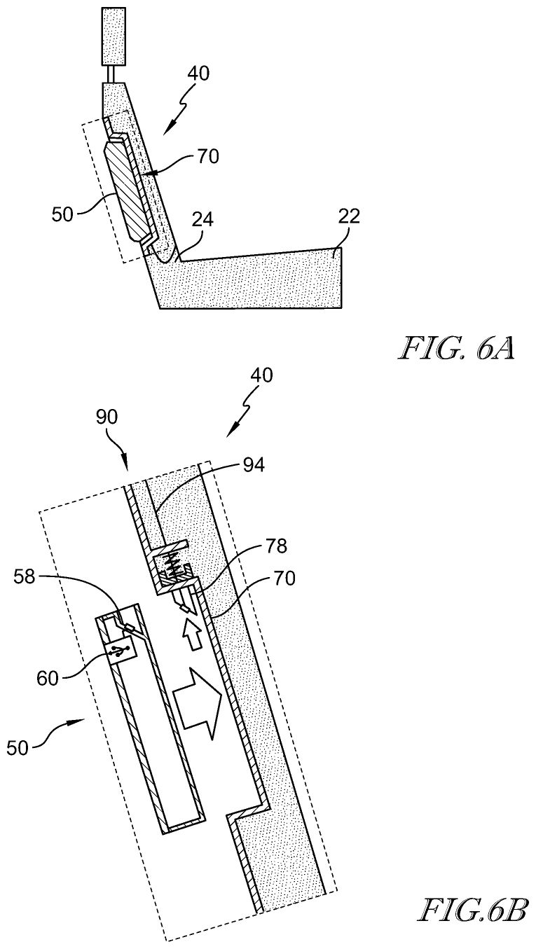

The platform-receiving mount 70 of the modular system 40 is mounted to the seat back 24 so as to move with the seat back 24 as shown in FIGS. 1 and 8 and suggested in FIGS. 6A-7 and 10. The platform-receiving mount 70 is formed to include a cavity in which the platform 50 may be mounted in the stowed configuration of the modular system 40. The platform-receiving mount 70 may include at least one anchor 78 configured to mate with at least one anchor 58 arranged on the platform 50. The platform 50 is coupled to the platform-receiving mount 70 via the anchors 58, 78, and furthermore, the battery 92 housed within the platform 50 is charged via the connection between the anchors 58, 78.

The modular system 40 is changeable between the stowed configuration (FIG. 2) and the use configuration (FIG. 1). In the stowed configuration, the platform 50 is releasably coupled to the platform-receiving mount 70 such that the platform 50 moves with the seat back 24. In the use configuration, the platform 50 is decoupled from the platform-receiving mount 70 so as to allow the platform 50 to move relative to the platform-receiving mount 70 and the seat back 24. In the use configuration, an occupant of the vehicle 100, such an occupant sitting behind the vehicle seat 20, may utilize the platform 50 for various purposes, which will be described below. For example, the occupant may utilize the platform 50 to support an electronic appliance, such as a laptop computer, to heat and/or cool the occupant, and/or to cool the electronic component being supported on the platform 50.

The occupant support 10 includes the vehicle seat 20 as shown in FIGS. 1 and 2. In the illustrative embodiment, the vehicle seat 20 is arranged in the vehicle 100 as a front vehicle seat 20, and a separate vehicle seat is arranged in the vehicle 100 as a rear vehicle seat. The vehicle seat 20 may be the passenger side front seat or the driver side front seat. The vehicle seat 20 includes the seat bottom 22 and the seat back 24 and is configured to support an occupant of the vehicle seat 20. The seat bottom 22 is arranged to overlie a floor of the vehicle 100 and is arranged substantially parallel with the floor. The seat bottom 22 may be configured to raise and lower, as well as pivot, relative to the floor of the vehicle 100.

The seat back 24 extends substantially vertically away from the seat bottom 22 and supports the back of an occupant of the vehicle seat 20 as shown in FIGS. 1 and 2. The seat back 24 includes a backrest cushion 23 formed on a front surface of the seat back 24 and left and right bolsters 25 arranged outwardly of the backrest cushion 23 on the sides of the seat back 24. A headrest 26 extends upwardly out of a top surface of the seat back 24 via headrest supports 27 and is positioned to support the head of the occupant.

The seat back 24 defines a rear surface 28 opposite the front surface, as can be seen in FIG. 1. The seat back 24 is formed to include a mount-receiving space 30 formed in the rear surface 28 of the seat back 24 and configured receive the platform-receiving mount 70. The rear surface 28 is formed to include a mount-receiving aperture 32 that opens into the mount-receiving space 28. The mount-receiving aperture 32 defines a first contour around an edge of the aperture 32 which is substantially the same as a second contour defined by an edge of an inner side wall 72 of the platform-receiving mount 70, which will be described below. Accordingly, the platform-receiving mount 70 fits securely within the mount-receiving space 30.

The mount-receiving space 30 is generally delimited by the surface area of the rear surface 28, as shown in FIG. 1. The aperture 32 of the space 30 does not occupy the entire surface area of the rear surface 28, but instead is sized to be slightly smaller so as to provide a portion of the rear surface 28 between the aperture 32 and the bolsters 25, and to provide a portion of the rear surface 28 between the aperture 32 and the top surface of the seat back 24. In at least some embodiments, the mount-receiving space 30 is sized so as to not interfere with a vertical frame 27 of the headrest 26 that extends downwardly into the seat back 24.

The mount system 40 includes the platform 50 and the platform-receiving mount 70 coupled to the seat back 24, as shown in FIGS. 1 and 2. The platform 50 is configured to be releasably coupled to the platform-receiving mount 70 such that an occupant of the vehicle 100 may selectively couple and decouple the platform 50 to and from the platform receiving mount 70. In the illustrative embodiment, the mount system 40 also includes a power system 90 connected to a vehicle power supply 110 of the vehicle 100, which will be described below.

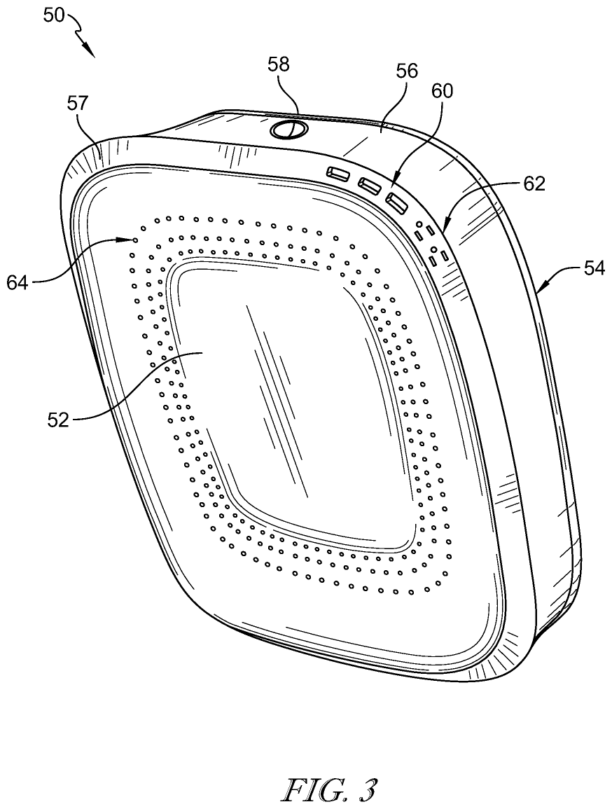

The platform 50 includes a top platform surface 52, a bottom platform surface 54, and a side platform wall 56 that extends around the outer edges of the top and bottom platform surfaces 52, 54, as shown in FIGS. 1-3. In at least some embodiments, the platform 50 includes a transition surface 57 that extends between the top surface 52 and the side platform wall 56. The transition surface 57 defines a lip that extends outwardly further than the side platform wall 56, as shown in FIG. 3. The platform 50 also includes at least one anchor 58 configured to couple to a corresponding anchor 78 of the platform-receiving mount 70. The anchors 58, 78 may be included as part of the power system 90 of the modular system 40.

The platform 50 is generally box shaped, with the top platform surface 52, the bottom platform surface 54, and the side platform wall 56 including four sides that are each generally parallel to an opposite side, as shown in FIG. 3. The four sides of the platform 50 may have rounded transitions so as to more closely match the shape of the seat back 24 and create a more aesthetically appealing presentation. However, the platform 50 may include any other suitable shape so long as the platform 50 is capable of accommodating the functional components described below.

The platform 50 further includes functional components that may be used by an occupant of the vehicle 100, in particular a rear occupant of the vehicle 100. In some driving situations, especially those involving ride-hailing or car-pooling services, passengers of the vehicle 100 may wish to complete work-related tasks, place calls, relax, or other such activities. Moreover, drivers of ride-hailing or car-pooling services may wish to implement additional revenue sources in their vehicles. As such, the platform 50 is provided with components that may offer services and features to a passenger of the vehicle 100 for productivity, comfort, relaxation, or other such purposes.

For example, the platform 50 may be configured to support a laptop computer when placed in a horizontal position on the legs of a seated occupant of the vehicle 100. In the illustrative embodiment, the platform 50 includes at least one data connection receptacle 60 and at least one power outlet 62. The platform 50 includes three universal serial bus (USB) receptacles 60 that an occupant may use to charge external electronic devices or to connect external devices to software of the vehicle 100 as shown in FIG. 3. The platform 50 further includes two power outlets 62 that are configured as Type B (three prong) outlets. The platform 50 may include any suitable number of receptacles and outlets, different types of connections points and outlets in other embodiments, such as Type A, C, and D outlets depending on the country of use, SD card receptacles, audio jacks, and the like.

The receptacles 60 and outlets 62 are disposed on the transition surface 57, as shown in FIGS. 1-3. In this position, the receptacles 60 and outlets 62 do not interfere with a laptop being placed on the top platform surface 52. Moreover, the receptacles 60 and outlets 62 remain accessible when the platform 50 is in coupled to the platform-receiving mount 70 in the stowed position, as can be seen in FIG. 2. In other embodiments, the receptacles 60 and the outlets 62 may be placed in other areas of the platform 50. For example, connection receptacles that would not be used when the platform 50 is coupled to the platform-receiving mount 70 in the stowed position could be positioned on the side platform wall 56. The connection receptacles and outlets may be configured in combinations that allow some connections to be utilized in both the stowed and use configurations, and other connections to only be utilized in one of the use configuration and the stowed configuration.

The top platform surface 52 is configured to support a laptop computer or similar external electronics device, as shown in FIGS. 3 and 5. The platform 50 is sized in order to accommodate a moderately sized electronic device such as a laptop. Specifically, the horizontal width of the platform 50 is sized to be approximately equal to the flat portion of the rear surface 28 of the seat back 24, and terminates where the rear surface 28 begins to curve towards the bolsters 25, as shown in FIGS. 1 and 2. Because laptop computers typically have a diagonal screen size of between eleven (11) inches and seventeen (17) inches, the top platform surface 52 has a diagonal length dimension of nineteen (19) inches in order to provide sufficient surface area to support such a laptop computer. In other embodiments, the top platform surface 52 may be sized differently in order to accommodate other similar external electronics.

Because external electronics such as laptop computers experience increased internal temperatures during operation, the top platform surface 52 further includes a plurality of holes 64, as shown in FIGS. 1-3 and 5. The plurality of holes 64 are configured to blow cooling air outwardly away from the top platform surface 52, via an internal fan or other such cooling device 66 housed within the platform 50. By blowing cooling air out of the holes 64, the external electronic device resting on top of the top platform surface 52 is cooled. The plurality of holes 64 may extend around the top platform surface 52, as shown in FIG. 3, or may be arranged in any pattern that provides sufficient cooling to the external electronic device.

In the illustrative embodiment, the bottom platform surface 54 also includes a temperature management system 66, in particular a system configured to heat and/or cool the occupant using the platform 50. A heating and/or a cooling device 66 may be housed within the platform 50 and configured to heat and/or cool the occupant, in particular the legs of the occupant as the platform 50 is resting on the legs of the occupant. The heating and/or cooling device 66 may also be directed to other portions of the occupant's body, for example blowing cooling air out of the side platform wall 56 facing the occupant so as to cool the upper body of the occupant.

The top platform surface 52 is formed as a substantially rigid surface so as to support a laptop computer or similar electronic device, as shown in FIGS. 3 and 5. In the illustrative embodiment, the top platform surface 52 may include a rigid internal piece of material, such as polymer or metal, surrounded by an outer non-slip cover. In this way, the external electronic device may rest on the top platform surface 52 without taking damage if the device shifts or is dropped onto the top platform surface 52.

The bottom platform surface 54 comprises soft materials so that the bottom platform surface 54 may comfortably rest on the legs of an occupant, in particular an occupant's thighs. The materials used for the bottom platform surface 54 may include any type of soft materials known in the art, such as a combination of foam, rubber, or other such materials. In at least some embodiments, the materials of the bottom surface must be configured to also allow the heating and/or cooling effects of the internal heating/cooling device to affect the occupant.

The platform-receiving mount 70 includes the inner side wall 72 that extends outwardly away from an inner bottom surface 74 so as to define a cavity in which the platform 50 may be mounted in the stowed configuration, as shown in FIGS. 1, 6A, and 6B. As discussed above, the inner side wall 72 defines a second contour which is substantially equal to the first contour of the mount-receiving aperture 32 such that the platform-receiving mount 70 fits securely within the mount-receiving space 30. The platform receiving mount 70 may be secured within the mount-receiving space 30 with bolts, screws, or any other suitable fasteners. In some embodiments, the platform-receiving mount 70 is inserted into the seat back 24 up until just before the frame (not shown) of the vehicle seat 20. As such, the platform-receiving mount 70 may be secured to the frame of the vehicle seat 20, while also not interfering with the vertical frame 27 of the headrest 26 that extends downwardly into the seat back 24.

The platform-receiving mount 70 includes at least one anchor 78, as shown in FIGS. 1 and 6B. In particular, the platform-receiving mount 70 includes two anchors 78. In some embodiments, the anchors 78 are arranged on opposite sides of the inner side wall 72, but may be arranged on the inner bottom surface 74 in other embodiments. The anchors 78 may include a securing device configured to secure the platform 50 to the platform-receiving mount 70 in the stowed configuration of the modular system 40. For example, the anchors 78 may include a latch mechanism with a quick release, high strength electromagnets, and/or friction attachments. One anchor 78, or both anchors 78, may also include electronic connections that are part of the power system 90 of the modular system 40.

The inner side wall 72 defines an outer perimeter edge that has the same contour as the contour of an outer perimeter edge of the top platform surface 52. Additionally, the platform 50 and the platform-receiving mount 70 have the same thickness. As such, when the platform 50 is coupled to the platform-receiving mount 70 in the stowed configuration, the platform 50 is substantially flush with the contour of the rear surface 28 of the seat back 24.

The anchor 58 of the platform 50 and the corresponding anchor 78 of the platform-receiving mount form an electronic connection when the two anchors 58, 78 are connected to each other, thus establishing an electronic connection between the platform 50 and the platform-receiving mount 70, as shown in FIG. 6B. The anchors 58, 78 are part of the power system 90 of the modular system 40. As discussed above, the power system 90 is connected to the vehicle power supply 110. The power system 90 is connected to the vehicle power supply 110 via an connection 94.

The power system 90 includes a rechargeable battery 92 housed within the platform 50 as shown in FIG. 7. The battery 92 is configured to power the various components of the platform 50, such as the data connections 60, the outlets 62, and the heating/cooling device 66. Moreover, the battery 92 is connected to the at least one anchor 58 of the platform 50 such that, when the anchor 58 is connected to the corresponding anchor 78 of the platform-receiving mount 70 in the stowed configuration, the battery 92 is charged via the electronic connection between the connected anchors 58, 78. The anchors 58, 78 may also include data connectors that allow external electronic devices to transfer data to the vehicle or receive data from the vehicle.

In other embodiments, the power system 90 includes a power cord 96 that is connected permanently to the platform 50 and the vehicle power supply 110 as shown in FIG. 8. The power cord 96 may be connected between the platform 50 and the platform-receiving mount 70, the seat back 24, or another portion of the vehicle 100, so long as it is at least indirectly connected to the vehicle power supply 110. In these embodiments, the power system 90 does not include a battery 92. Instead, the platform 50 is continuously powered by the vehicle power supply 110 via the power cord 96, thus reducing the overall weight and complexity of the platform 50. The anchors 58, 78 may still provide data connections from the platform to the vehicle, or may only be configured as mounting points for the stowed configuration of the modular system 40.

In one example of the modular system 40 in use, a rear occupant may enter the vehicle 100 while desiring to accomplish work-related tasks during the ride in the vehicle 100. Initially, the platform 50 is coupled to the platform-receiving mount 70 in the stowed configuration. In this configuration, the occupant may wish use the functional components located on the platform 50, such as the data connection 60 or outlets 62 in order to, for example, charge his or her cellular device. Then, if the occupant wishes to complete work on his or her laptop computer in a more comfortable scenario than placing the laptop on his or her thighs, the occupant may decouple the platform 50 from the platform-receiving mount 70 via an easy-release button or other such release mechanism.

Once the platform 50 has been removed from the platform-receiving mount 70, the occupant may place the platform 50 on his or her lap in order to subsequently place an external electronic device, such a laptop computer, on the top platform surface 52 of the platform 50. Optionally, the occupant may activate the heating/cooling device 66 to heat or cool the occupant's legs or other portions of the occupant's body. The occupant may also activate the cooling of the laptop via the plurality of holes 64 in the top platform surface 52. The occupant may also plug the laptop computer or other external electronic device into the outlet 62 or the data connection receptacle 60. When the occupant is finished using the platform 50, the occupant may remove the connections to the data connection receptacles 62 and outlets 60 and replace the platform 50 in the platform-receiving mount 70 via the anchors 58, 78.

In some embodiments, the platform 50 may include additional convenience features that improve the occupant's experience. For example, the platform 50 may include further attachments, such as trays that extend outwardly from the sides of the top platform surface 52 to permit the occupant to place work materials, such as papers or an external laptop mouse, on the trays. The platform 50 may also include a plurality of buttons that serve different functions, such as turning the heating/cooling device 66 on and off, alerting the driver to needs of the occupant, or other such uses.

In a second embodiment, an occupant support 110 includes a mount system 140 having anti-theft features such that an occupant may not freely remove a platform 150 of the mount system 140 from the vehicle 100, as shown in FIGS. 4 and 8. The components of the occupant support 110, in particular the mount system 140, the platform 150, and the platform-receiving mount 170, are configured substantially the same as the occupant support 10, the modular system 40, the platform 50, and the platform-receiving mount 70 described above.

In some embodiments, the vehicle 100 includes an alert system 102 configured to alert an occupant or the driver that the platform 150 has not been replaced in the platform-receiving mount 170 when a door of the vehicle 100 is opened. The alert system 102 includes a first sensor 104 configured to detect whether a door of the vehicle 100 is opened. The mount system 140 includes a second sensor 106 configured to detect whether the platform 150 is coupled to the platform-receiving mount 70. Accordingly, when the first sensor 104 detects that a door is open and the second sensor 106 detects that the platform 150 is not coupled to the platform-receiving mount 170, the alert system 102 may produce a visual or auditory indication to alert an occupant of the vehicle 100.

In at least some embodiments, the mount system 140 may include a tether 108 connected to the platform 150 and the seat back 24 or the platform-receiving mount 170. Thus, an occupant of the vehicle 100 could only move the platform 150 away from the seat back 24 a distance allowed by the tether 108. In some embodiments, the tether 108 may also include the power cord 196, as shown in FIG. 8.

In a third embodiment, and occupant support 210 includes a platform 250 providing other functional components that offer other services and features to a passenger of the vehicle 100 for productivity, comfort, relaxation, or other such purposes. The components of the occupant support 210, in particular the platform 250, are configured substantially the same as the occupant support 10 and the platform 50 described above. In some embodiments, the platform 250 is configured as a vending machine such that an occupant of a vehicle 100 may purchase various items such as food and drinks, as shown in FIG. 9. The platform 250 is formed similarly to the platform 50, with outlets, data connection receptacles, and the same surface configuration. The platform 250 also includes a recessed area 252 that houses a vending device, including a plurality of vending doors 254 that may be opened after payment is received by the occupant via a payment system 256.

It can be envisioned that the platform 50, 150, 250 may include other rear passenger entertainment solutions, such as a video player for in-ride viewing, a media player configured to play music selected by the passenger, an interactive touch screen including games or other entertainment options, or similar such solutions. The platform 50, 150, 250 may also include comfort solutions, such as temperature controls, foot or back massagers, seat controls, air purifier, or other such solutions. The platform 50, 150, 250 may also include additional compartments that serve as storage areas for occupants of the vehicle 100.

In embodiments in which the power system 90 of the modular system 40 includes a battery 92 housed in the platform 50, the platform 50 may be configured to be interchangeable with other platforms stored elsewhere in the vehicle 100. For example, a platform configured with entertainment solutions may be initially coupled to the platform-receiving mount 70. A separate platform, such as the platform 50 described above configured for use with a laptop computer, may be stored in the trunk of the vehicle 100. If the driver wishes to change the platform mounted in the platform-receiving mount 70 before a passenger enters the vehicle, for example if the passenger requests laptop accessibility via a ride-sharing software application, the driver may retrieve the platform from the trunk of the vehicle 100 and replace the entertainment platform with the laptop platform 50. Any number of alternative platforms may be stored in the vehicle 100, or elsewhere.

The present disclosure relates to a mount system for a vehicle. The mount system is changeable between a stowed configuration and a use configuration. More particularly, the present disclosure relates to a mount system including a platform and a platform-receiving mount. The platform receiving mount coupled to a vehicle seat of the vehicle and the platform is configured to be coupled to the platform-receiving mount in the stowed configuration, and decoupled from the platform-receiving mount in the use configuration.

The following numbered clauses include embodiments that are contemplated and non-limiting:

Clause 1. A vehicle comprising a first vehicle seat including a seat bottom arranged to overlie a floor of the vehicle and a seat back arranged to extend upwardly away from the seat bottom, and a second vehicle seat located rearward of the first vehicle seat.

Clause 2. The vehicle of clause 1, any other clause, or combination of clauses, further comprising a modular system including a platform-receiving mount coupled to the first vehicle seat to move therewith, a first platform, and a power system.

Clause 3. The vehicle of clause 2, any other clause, or combination of clauses, wherein the modular system is changeable between a stowed configuration, in which the first platform is releasably coupled to the platform-receiving mount to move therewith, and a use configuration, in which the first platform is decoupled from the platform-receiving mount so as to allow the first platform to move relative to the platform-receiving mount and the seat back such that an occupant of the second vehicle seat may use the first platform.

Clause 4. The vehicle of clause 3, any other clause, or combination of clauses, wherein the platform-receiving mount includes a first anchor member, the first platform includes a second anchor member, and the first anchor member and the second anchor member are configured to releasably couple to each other so as to releasably couple the first platform to the platform-receiving mount in the stowed configuration.

Clause 5. The vehicle of clause 4, any other clause, or combination of clauses, wherein the vehicle includes a vehicle power supply, and the power system of the modular system is connected to the vehicle power supply so as to power the modular system.

Clause 6. The vehicle of clause 5, any other clause, or combination of clauses, wherein a rear surface of the seat back is formed to include a mount-receiving aperture formed to open into a mount-receiving space formed in the seat back, the mount-receiving aperture and the mount-receiving space configured to receive the platform-receiving mount, and wherein the platform-receiving mount is mounted in the mount-receiving space.

Clause 7. The vehicle of clause 6, any other clause, or combination of clauses, wherein a first outer perimeter edge of the mount-receiving aperture defines a first contour.

Clause 8. The vehicle of clause 7, any other clause, or combination of clauses, wherein the platform-receiving mount includes an inner bottom surface and an inner side wall arranged to extend away from the inner bottom surface and having a second outer perimeter edge, the second outer perimeter edge defining a second contour that is the same as the first contour.

Clause 9. The vehicle of clause 8, any other clause, or combination of clauses, wherein the first platform includes a top platform surface, a bottom platform surface, and a side platform wall that extends between the top platform surface and the bottom platform surface.

Clause 10. The vehicle of clause 9, any other clause, or combination of clauses, wherein a third outer perimeter edge of the top platform surface defines a third contour that is the same as the first contour.

Clause 11. The vehicle of clause 10, any other clause, or combination of clauses, wherein the side platform wall extends a first distance between the top platform surface and the bottom platform surface, the inner side wall extends away from the inner bottom surface a second distance, and the first distance is equal to the second distance.

Clause 12. The vehicle of clause 5, any other clause, or combination of clauses, wherein the power system of the modular system includes a battery disposed in the first platform to move therewith, the battery configured to connect to the vehicle power supply via the first anchor member and the second anchor member when in the stowed configuration.

Clause 13. The vehicle of clause 5, any other clause, or combination of clauses, wherein the power system of the modular system includes a power cord arranged to extend between the seat back and the first platform so as to provide continuous power from the vehicle power supply to the first platform.

Clause 14. The vehicle of clause 11, any other clause, or combination of clauses, wherein the first platform further includes a transition surface that extends between the side platform wall and the top platform surface, and the transition surface includes at least one of a power outlet and a data connection receptacle.

Clause 15. The vehicle of clause 14, any other clause, or combination of clauses, wherein the transition surface is exposed when the first platform is in the stowed configuration such that the at least one of the power outlet and the data connection receptacle are accessible to connect to external electronics.

Clause 16. The vehicle of clause 9, any other clause, or combination of clauses, wherein the top platform surface is substantially flat and substantially rigid and the bottom platform surface is formed as an elastically deformable surface adapted to rest on legs of an occupant of the vehicle when the modular system is in the use configuration.

Clause 17. The vehicle of clause 13, any other clause, or combination of clauses, wherein the modular system further includes a tether extending from the seat back to the first platform and is configured to block removal of the first platform from the vehicle when the first platform is decoupled from the platform-receiving mount.

Clause 18. The vehicle of clause 3, any other clause, or combination of clauses, further comprising a control system including a first sensor configured to detect when at least one door of the vehicle is opened, a second sensor configured to detect when the modular system is in the stowed configuration, and an output configured to produce a sensory alert when the first sensor detects that at least one door of the vehicle is opened and the second sensor detects that the first platform is not in the stowed configuration.

Clause 19. The vehicle of clause 16, any other clause, or combination of clauses, wherein the first platform includes a first thermal control system configured to provide a first thermal sensation to the occupant of the vehicle via the bottom platform surface, and a second thermal sensation to an area above the top platform surface, wherein the first thermal sensation is a heating or cooling effect, and the second thermal sensation is a cooling effect.

Clause 20. The vehicle of clause 19, any other clause, or combination of clauses, wherein the top platform surface is configured to support a laptop computer, and wherein the first thermal control system is configured to cool the laptop computer via a plurality of holes formed in the top platform surface.

Clause 21. The vehicle of clause 9, any other clause, or combination of clauses, wherein the first platform is formed to include an aperture arranged to open into a platform space formed in the first platform and the platform space is configured to store an occupant assistance device therein.

Clause 22. The vehicle of clause 5, any other clause, or combination of clauses, wherein the modular system further includes a second platform changeable between a stowed configuration, in which the second platform is releasably coupled to the platform-receiving mount to move therewith and the first platform is decoupled from the platform-receiving mount, in which the second platform is decoupled from the platform-receiving mount so as to allow the second platform to move relative to the platform-receiving mount and the seat back such that an occupant of the second vehicle seat may use the second platform.

Clause 23. The vehicle of clause 22, any other clause, or combination of clauses, wherein the power system of the modular system includes a second battery disposed in the second platform and configured to connect to the vehicle power supply via the first anchor member and a third anchor member of the second platform being coupled to each other.

Clause 24. An occupant support comprising a vehicle seat including a seat bottom and a seat back arranged to extend upwardly away from the seat bottom, and a modular system including a platform and a platform-receiving mount coupled to the vehicle seat to move therewith.

Clause 25. The occupant support of clause 24, any other clause, or combination of clauses, wherein the modular system is changeable between a stowed configuration, in which the platform is releasably coupled to the platform-receiving mount to move therewith, and a use configuration, in which the platform is decoupled from the platform-receiving mount so as to allow the platform to move relative to the platform-receiving mount and the seat back such that an occupant of the a vehicle in which the occupant support is arranged may use the platform.

Clause 26. The occupant support of clause 25, any other clause, or combination of clauses, wherein the platform-receiving mount includes a first anchor member, the platform includes a second anchor member, and the first anchor member and the second anchor member are configured to releasably couple to each other so as to releasably couple the platform to the platform-receiving mount in the stowed configuration.

Clause 27. The occupant support of clause 26, any other clause, or combination of clauses, wherein the power system of the modular system is connected to a vehicle power supply of the vehicle so as to power the modular system.

Clause 28. The occupant support of claim 27, any other clause, or combination of clauses, wherein a rear surface of the seat back is formed to include a mount-receiving aperture formed to open into a mount-receiving space formed in the seat back, the mount-receiving aperture and the mount-receiving space configured to receive the platform-receiving mount.

Clause 29. The occupant support of claim 28, any other clause, or combination of clauses, wherein the platform-receiving mount is mounted in the mount-receiving space, wherein a first outer perimeter edge of the mount-receiving aperture defines a first contour, wherein the platform-receiving mount includes an inner bottom surface and an inner side wall arranged to extend away from the inner bottom surface and having a second outer perimeter edge, the second outer perimeter edge defining a second contour that is the same as the first contour.

Clause 30. The occupant support of claim 29, any other clause, or combination of clauses, wherein the platform includes a top platform surface, a bottom platform surface, and a side platform wall that extends between the top platform surface and the bottom platform surface, wherein a third outer perimeter edge of the top platform surface defines a third contour that is the same as the first contour.

Clause 31. The occupant support of claim 30, any other clause, or combination of clauses, wherein the side platform wall extends a first distance between the top platform surface and the bottom platform surface, the inner side wall extends away from the inner bottom surface a second distance, and the first distance is equal to the second distance.

Clause 32. The occupant support of clause 27, any other clause, or combination of clauses, wherein the power system of the modular system includes a battery disposed in the platform to move therewith, the battery configured to connect to the vehicle power supply via the first anchor member and the second anchor member when in the stowed configuration.

Clause 33. The occupant support of clause 27, any other clause, or combination of clauses, wherein the power system of the modular system includes a power cord arranged to extend between the seat back and the platform so as to provide continuous power from the vehicle power supply to the platform.

Clause 34. The occupant support of clause 31, any other clause, or combination of clauses, wherein the platform further includes a transition surface that extends between the side platform wall and the top platform surface, the transition surface includes at least one of a power outlet and a data connection receptacle.

Clause 35. The occupant support of clause 34, any other clause, or combination of clauses, wherein the transition surface is exposed when the platform is in the stowed configuration such that the at least one of the power outlet and the data connection receptacle are accessible to connect to external electronics.

Clause 36. The occupant support of clause 35, any other clause, or combination of clauses, wherein the top platform surface is substantially flat and substantially rigid, and the bottom platform surface is formed as an elastically deformable surface adapted to rest on legs of an occupant of the vehicle when the modular system is in the use configuration.

Clause 37. The occupant support of clause 36, any other clause, or combination of clauses, wherein the platform includes a first thermal control system configured to provide a first thermal sensation to the occupant of the vehicle via the bottom platform surface, and a second thermal sensation to an area above the top platform surface, wherein the first thermal sensation is a heating or cooling effect, and the second thermal sensation is a cooling effect.

Clause 38. A method comprises coupling a platform-receiving mount of a modular system to a seat back of a vehicle seat such that the platform-receiving mount moves with the seat back.

Clause 39. The method of clause 38, any other clause, or combination of clauses, further comprising coupling a platform of the modular system to the platform-receiving mount to move therewith so as to establish a stowed configuration.

Clause 40. The method of clause 39, any other clause, or combination of clauses, further comprising separating the platform from the platform-receiving mount to establish a use configuration and allow the platform to move relative to the platform-receiving mount and the seat back.

1. A vehicle comprising
a first vehicle seat including a seat bottom arranged to overlie a floor of the vehicle and a seat back arranged to extend upwardly away from the seat bottom,
a second vehicle seat located rearward of the first vehicle seat, and
a modular system including a platform-receiving mount coupled to the first vehicle seat to move therewith and a first platform,
wherein the modular system is changeable between a stowed configuration, in which the first platform is releasably coupled to the platform-receiving mount to move therewith, and a use configuration, in which the first platform is decoupled from the platform-receiving mount so as to allow the first platform to move relative to the platform-receiving mount and the seat back such that an occupant of the second vehicle seat may use the first platform.

2. The vehicle of claim 1, wherein the platform-receiving mount includes a first anchor member, the first platform includes a second anchor member, and the first anchor member and the second anchor member are configured to releasably couple to each other so as to releasably couple the first platform to the platform-receiving mount in the stowed configuration.

3. The vehicle of claim 2, wherein the vehicle includes a vehicle power supply, and the modular system includes a power system which is connected to the vehicle power supply to power the modular system.

4. The vehicle of claim 3, wherein a rear surface of the seat back is formed to include a mount-receiving aperture arranged to open into a mount-receiving space formed in the seat back, the mount-receiving aperture and the mount-receiving space are configured to receive the platform-receiving mount, and wherein the platform-receiving mount is mounted in the mount-receiving space, wherein a first outer perimeter edge of the mount-receiving aperture defines a first contour, wherein the platform-receiving mount includes an inner bottom surface and an inner side wall arranged to extend away from the inner bottom surface and having a second outer perimeter edge, the second outer perimeter edge defining a second contour that is the same as the first contour.

5. The vehicle of claim 4, wherein the first platform includes a top platform surface, a bottom platform surface, and a side platform wall that extends between the top platform surface and the bottom platform surface, wherein a third outer perimeter edge of the top platform surface defines a third contour that is the same as the first contour, and wherein the side platform wall extends a first distance between the top platform surface and the bottom platform surface, the inner side wall extends away from the inner bottom surface a second distance, and the first distance is equal to the second distance.

6. The vehicle of claim 3, wherein the power system of the modular system includes a battery disposed in the first platform to move therewith, the battery is configured to connect to the vehicle power supply via the first anchor member and the second anchor member when in the stowed configuration.

7. The vehicle of claim 3, wherein the power system of the modular system includes a power cord arranged to extend between the seat back and the first platform so as to provide continuous power from the vehicle power supply to the first platform.

8. The vehicle of claim 1, further comprising
a control system including a first sensor configured to detect when at least one door of the vehicle is opened, a second sensor configured to detect when the modular system is in the stowed configuration, and an output configured to produce a sensory alert when the first sensor detects that at least one door of the vehicle is opened and the second sensor detects that the first platform is not in the stowed configuration.

9. The vehicle of claim 3, wherein the modular system further includes a second platform changeable between a stowed configuration, in which the second platform is coupled releasably to the platform-receiving mount to move therewith and the first platform is decoupled from the platform-receiving mount, and a use configuration, in which the second platform is decoupled from the platform-receiving mount so as to allow the second platform to move relative to the platform-receiving mount and the seat back such that an occupant of the second vehicle seat may use the second platform.

10. An occupant support comprising
a vehicle seat including a seat bottom and a seat back arranged to extend upwardly away from the seat bottom, and
a modular system including a platform and a platform-receiving mount coupled to the vehicle seat to move therewith, the modular system being changeable between a stowed configuration, in which the platform is releasably coupled to the platform-receiving mount to move therewith, and a use configuration, in which the platform is decoupled from the platform-receiving mount so as to allow the platform to move relative to the platform-receiving mount and the seat back such that an occupant of a vehicle in which the occupant support is arranged may use the platform.

11. The occupant support of claim 10, wherein the platform-receiving mount includes a first anchor member, the platform includes a second anchor member, and the first anchor member and the second anchor member are configured to releasably couple to each other so as to releasably couple the platform to the platform-receiving mount in the stowed configuration.

12. The occupant support of claim 11, wherein the power system of the modular system is connected to a vehicle power supply of the vehicle so as to power the modular system.

13. The occupant support of claim 12, wherein a rear surface of the seat back is formed to include a mount-receiving aperture formed to open into a mount-receiving space formed in the seat back, the mount-receiving aperture and the mount-receiving space configured to receive the platform-receiving mount, and wherein the platform-receiving mount is mounted in the mount-receiving space, wherein a first outer perimeter edge of the mount-receiving aperture defines a first contour, wherein the platform-receiving mount includes an inner bottom surface and an inner side wall arranged to extend away from the inner bottom surface and having a second outer perimeter edge, the second outer perimeter edge defining a second contour that is the same as the first contour.

14. The occupant support of claim 13, wherein the platform includes a top platform surface, a bottom platform surface, and a side platform wall that extends between the top platform surface and the bottom platform surface, wherein a third outer perimeter edge of the top platform surface defines a third contour that is the same as the first contour, and wherein the side platform wall extends a first distance between the top platform surface and the bottom platform surface, the inner side wall extends away from the inner bottom surface a second distance, and the first distance is equal to the second distance.

15. The occupant support of claim 12, wherein the power system of the modular system includes a battery disposed in the platform to move therewith, the battery configured to connect to the vehicle power supply via the first anchor member and the second anchor member when in the stowed configuration.

16. The occupant support of claim 12, wherein the power system of the modular system includes a power cord arranged to extend between the seat back and the platform so as to provide continuous power from the vehicle power supply to the platform.

17. The occupant support of claim 14, wherein the platform further includes a transition surface that extends between the side platform wall and the top platform surface, the transition surface includes at least one of a power outlet and a data connection receptacle, and the transition surface is exposed when the platform is in the stowed configuration such that the at least one of the power outlet and the data connection receptacle are accessible to connect to external electronics.

18. The vehicle of claim 14, wherein the top platform surface is substantially flat and substantially rigid, and the bottom platform surface is formed as an elastically deformable surface adapted to rest on legs of an occupant of the vehicle when the modular system is in the use configuration, wherein the platform includes a first thermal control system configured to provide a first thermal sensation to the occupant of the vehicle via the bottom platform surface, and a second thermal sensation to an area above the top platform surface, wherein the first thermal sensation is a heating or cooling effect, and the second thermal sensation is a cooling effect.

19. A method comprising
coupling a platform-receiving mount of a modular system to a seat back of a vehicle seat such that the platform-receiving mount moves with the seat back,
coupling a platform of the modular system to the platform-receiving mount to move therewith so as to establish a stowed configuration, and
separating the platform from the platform-receiving mount to establish a use configuration and allow the platform to move relative to the platform-receiving mount and the seat back.
